(19) United States
(12) Patent Application Publication
(10) Pub. No.: US 2022/0194553 A1
(43) Pub. Date: Jun. 23, 2022

(54) MODULAR AEROSTRUKTUR ASSEMBLY

(71) Applicant: AIRBUS OPERATIONS GMBH, Hamburg (DE)

(72) Inventors: Henrik LÜTTMANN, Hamburg (DE); Rombs WILHELM, Hamburg (DE); Guido KUHLMANN, Hamburg (DE); René SCHRÖDER, Hamburg (DE)

(21) Appl. No.: 17/606,396

(22) PCT Filed: Apr. 21, 2020
(86) PCT No.: PCT/EP2020/061070

§ 371 Date: Oct. 25, 2021

(30) Foreign Application Priority Data
Apr. 26, 2019 (GB) 1905857.7

(51) Int. Cl. B64C 5/02; B64C 1/26

(52) U.S. Cl. CPC B64C 5/02; B64C 2211/00; B64C 1/26

(57) ABSTRACT

An aerostructure assembly of an aircraft is disclosed having a first aerostructure portion extending in a direction between a first position and a second position and including structurally of at least one rib or spar portion at least partially enclosed by a cover portion; a corresponding second aerostructure portion connected to the first aerostructure portion and extending continuously in the direction from the first aerostructure portion between the second position and a third position and including structurally of at least one further rib or further spar portion at least partially enclosed by a further cover portion. The first aerostructure portion has a first aerodynamic planform area (SI) and the corresponding second aerostructure portion has a corresponding second aerodynamic planform area (S2). A total aerodynamic planform area of the first aerostructure portion and corresponding second aerostructure portion is equal to the sum of the first aerodynamic planform area and the corresponding second aerodynamic planform area.

### TECHNICAL FIELD

The present invention relates to an aerostructure assembly and an aircraft comprising such an aerostructure assembly.

### BACKGROUND

For each new aircraft programme, the final design of the aircraft is a carefully selected compromise (both structurally and aerodynamically) between the performance requirements to be met by the aircraft in terms of payload, range, fuel burn, low speed and high speed performance, and the unit and operation costs of the aircraft. Other constraints may also apply.

The result is a design only suitable for a single aircraft and its various system and aerostructure components. Such designs are highly bespoke in terms of component dimensions, materials and associated manufacturing processes, and are thus high cost, and not sized to be used for a second different aircraft that has a different set of performance or cost requirements.

It is the object of embodiments of the present invention to enable the design of a plurality of aircraft that have interchangeable and common aerostructure or system components. Although this may result in lower (yet acceptable) performance characteristics for a given aircraft design, it lowers unit and operational costs due to the reduced design, certification and manufacturing costs of the interchangeable and common aerostructure or system components that are sized (in terms of materials, dimensions and performance) for a plurality of aircraft rather than a single aircraft.

The object is solved by the features of the independent claims. Advantageous embodiments are subject matter of the dependent claims and the following description.

### SUMMARY OF THE INVENTION

An embodiment of the present invention provides an aerostructure assembly of an aircraft comprising a first aerostructure portion extending in a direction between a first position and a second position and comprising structurally of at least one rib or spar portion at least partially enclosed by a cover portion; a corresponding second aerostructure portion connected to the first aerostructure portion and extending continuously in the direction from the first aerostructure portion between the second position and a third position and comprising structurally of at least one further rib or further spar portion at least partially enclosed by a further cover portion; wherein the first aerostructure portion has a first aerodynamic planform area and the corresponding second aerostructure portion has a corresponding second aerodynamic planform area; wherein a total aerodynamic planform area of the first aerostructure portion and corresponding second aerostructure portion is equal to the sum of the first aerodynamic planform area and the corresponding second aerodynamic planform area; wherein the total aerodynamic planform area and structural component characteristics of the first aerostructure portion and the corresponding second aerostructure portion are defined such that the aerostructure assembly is sized for use on the aircraft; and, wherein the aerodynamic planform area and the structural characteristics of the first aerostructure portion are in addition sized for use on a second aircraft.

Said design of the first aerostructure portion of the aerostructure assembly is advantageous in that it is sized (both aerodynamically and structurally) for use on a plurality of aircraft. This reduces the costs of developing and certifying the plurality of aircraft because only a single sizing activity is required.

Furthermore, as the aerostructure assembly is sized for use on multiple aircraft, it will have structural components (spar, cover, ribs, actuator brackets, actuators, etc.) whose design characteristics (in terms of material, dimension and performance) that are common or interchangeable between the plurality of aircraft. This means that significant parts of the manufacturing process and associated manufacturing tooling and assembly line required to manufacture the aerostructure assemblies for the plurality of aircraft may be the same. Increased use of manufacturing automation may be possible where sufficient quantities of the same aerostructure assembly are being made for a plurality of aircraft. As such the design of the aerostructure assembly is more adaptable or “modular” meaning that the design the aerostructure assembly may comprise a common, interchangeable first aerostructure portion that can be connected to a corresponding second aerostructure portion that is bespoke for a given aircraft.

These possibilities may significantly reduce the unit costs of the aerostructure assembly (and thus the aircraft) and may also significantly reduce the operational cost of the aerostructure assembly (and thus the aircraft) as it will be easier to source replacement parts that are common with a plurality of aircraft).

In a further embodiment of the present invention the cover portion of the first aerostructure portion and the further cover portion of the corresponding second aerostructure portion are formed as a unitary component. In yet a further embodiment of the present invention the spar portion of the first aerostructure portion and the further spar portion of the corresponding second aerostructure portion are formed as a unitary component. Said forming of the covers and spars of the first and second aerostructure portions as unitary component, may allow the covers or spars to be moulded and jigged using a single mould and jig tool. This may be advantageous in that it would reduce investment in the manufacturing and assembly process for the aerostructure assembly to be used for a plurality of aircraft. Furthermore, it may ensure that the part dimensions for the cover or spar of the first aerostructure portion is exactly the same for the plurality of aircraft embodying it. This would reduce variation in the manufactured dimensions of the parts and ensure part commonality and interchangeability.

In another embodiment of the present invention, the first aerostructure portion may comprise at least one hinge, at least one actuator support bracket and at least one actuator suited for use on both a first aircraft and a second aircraft. This may be advantageous in some aerostructure assemblies that incorporate actuator bracket(s) and actuator(s) because it may result in a design where the actuator bracket(s) and actuator(s) are interchangeable or parts in common with a plurality of aircraft. This may reduce not only the unit cost, but also the operational cost of such aerostructure assemblies.

In yet another embodiment of the present invention, the aerostructure assembly may further comprise an attachment assembly configured to attach the second corresponding portion of the aerostructure assembly to a further aerostructure assembly of the aircraft, wherein the attachment assembly comprises at least two lugs each configured to be attached by a pin to at least one corresponding clevis, and wherein the distance between the lugs c is less than or equal to the length d of the first aerostructure portion at the second position. Said embodiment may be advantageous in that the attachment lug position will be the same for an aerostructure comprising just the first aerostructure portion and a separate aerostructure assembly comprising the first and second aerostructure portions, meaning in other words that the attachment assembly for a plurality of aircraft is dimensionally the same. This is advantageous in that it permits commonality in attachment tooling and design of the attachment assembly on the further aerostructure assembly, which may be used for multiple aircraft types. In the examples provided in the detailed description, the further aerostructure assembly of the aircraft is an aircraft fuselage, where this embodiment is particularly advantageous where the same a similar fuselage section is used for different aircraft variants (for example stretch variants of a specific aircraft type). However it should be appreciated by the skilled person that the further aerostructure assembly may be any separate aerostructure assembly to which the aerostructure assembly of the present invention is to be attached, for example, a wing.

In the present embodiment, the lugs may be integrally formed with the cover portion, the further cover portion, the opposite cover, the further opposite cover or the at least one further rib of the first aerostructure portion or corresponding second aerostructure portion. Such a design is advantageous in that the lugs may be machined, cured or bonded with/to the cover(s) or rib(s) using a single mould tool. This may be advantageous in that it would reduce investment in the manufacturing and assembly process for the aerostructure assembly to be used for a plurality of aircraft. It also will result in a lighter design that takes less time to manufacture. Furthermore, it may ensure that the part dimensions for the cover or rib with lugs of the second aerostructure portion is exactly the same for the plurality of aircraft embodying it. This would reduce variation in the manufactured dimensions of the parts and ensure part commonality and interchangeability.

The lugs may alternatively be separate fittings mechanically fastened to the first aerostructure portion or the second corresponding portion. It may be advantageous to incorporate the lugs this way where a design with improved reparability or where interchangeability of the lugs with the addition of the cover or rib is required.

In further embodiments of the present invention, the first and second aerostructure portions of the aerostructure assembly may be portions of a leading edge assembly or trailing edge assembly or torsion box assembly incorporated in a vertical tail plane or horizontal tail plane or a wing of an aircraft. Such portions of an aerostructure assembly are particularly suited to the present invention due to their otherwise high cost and level of bespoke design.

Another embodiment of the present invention, comprises an aircraft comprising an aerostructure assembly according the any abovementioned embodiment of the present invention. Such an embodiment is advantageous in that it may result in an aircraft of lower unit or operational cost compared to the state of the art.

Further advantages of the present invention will now become apparent from the detailed description with appropriate reference to the accompanying drawings.

### BRIEF DESCRIPTION OF THE DRAWINGS

Embodiments of the present invention presented herein are described below with reference to the following drawings, in which:

FIG. 1 provides a schematic side view of a first aircraft 100 comprising a vertical tail plane 105 further comprising a torsion box assembly 111, a leading edge assembly 107 and a trailing edge assembly 109 according to embodiments of the present invention;

FIG. 2 provides schematic side view of the aircraft vertical tail 105 of FIG. 1.

FIG. 3 provides a further schematic side of the aircraft vertical tail 105 of FIG. 2 and a pair of separate cross-sectional views 3A and 3B of the torsion box assembly 111 of FIG. 3 taken horizontally through section line A-A and section line B-B, respectively.

FIG. 4 provides a schematic side view of a further aircraft 400 comprising a vertical tail plane 405 further comprising a torsion box assembly 411 a leading edge assembly 407 and a trailing edge assembly 409 with the same aerodynamic and structural component design as the leading edge, trailing edge and torsion box assemblies 107, 109, 111 as the vertical tail plane 105 of FIG. 1, 2, 3, 3A and 3B.

FIG. 5 provides schematic side view of the aircraft vertical tail 405 of FIG. 4.

### DETAILED DESCRIPTION

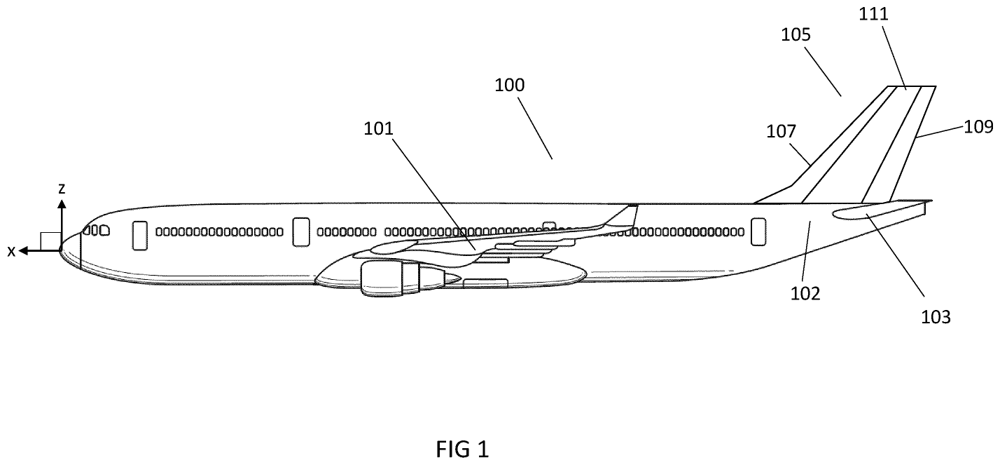

With reference to FIGS. 1, a first aircraft 100 is shown comprising a plurality of aerostructure assemblies such as the wing 101, horizontal tail 103, and vertical tail 105 that are attached to a further aerostructure assembly called the aircraft fuselage 102. The first aircraft 100 comprises a set of orthogonal aircraft axes, comprising a longitudinal X axis, a lateral Y axis, and a vertical Z axis. The X axis is approximately aligned with a chord wise direction of the wing 101, horizontal tail 103 and vertical tail 105. The direction of the lateral Y axis is offset by a sweep angle A (not shown) typically of 30 degrees with the spanwise direction of the wing 101 and separately of the horizontal tail 103. The direction of the vertical Z axis is similarly offset by a sweep angle Φ typically of 30 degrees with the spanwise direction of the vertical tail 105. The region of an aerostructure assembly existing in the most positive X direction is commonly referred to as the leading edge region of the aerostructure assembly and referred to as the trailing edge in the most negative X direction.

Each aerostructure assembly 101, 103 105 comprises a leading edge assembly 107, a trailing edge assembly 109, and a torsion box assembly 111 therebetween. The wing 101, and tails 103, 105 further comprise a plurality of smaller aerostructure assemblies such as slats and flaps and false work that are constructed in substantially the same way as the larger structures in that they comprise spars and/or ribs and/or stiffeners bounded by one or more outer cover(s).

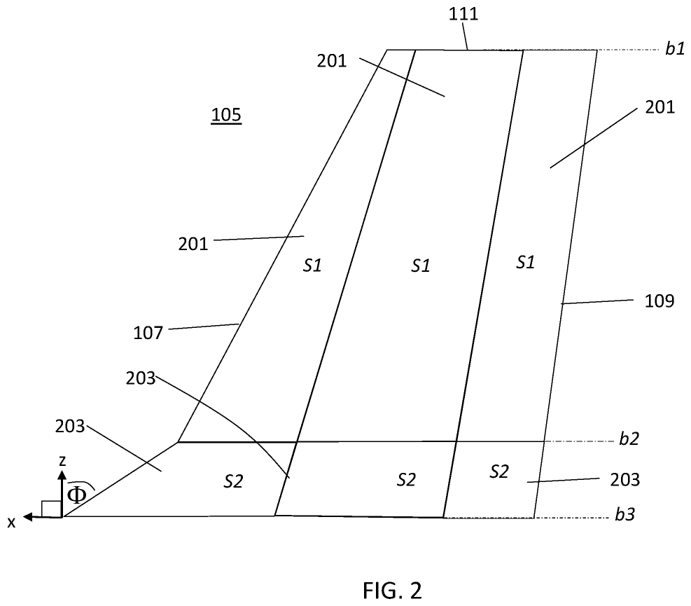

With reference to FIG. 2, the leading edge assembly 107, trailing edge assembly 109, and a torsion box assembly 111 of the vertical tail 105 each comprises a first aerostructure portion 201 connected to a corresponding second aerostructure portion 203. Each first aerostructure portion 201 extends in a spanwise direction between a first position b1 and a second position b2.

Each corresponding second aerostructure portion 203 extends continuously in the spanwise direction from the first aerostructure portion 201 between the second position b2 and a third position b3.

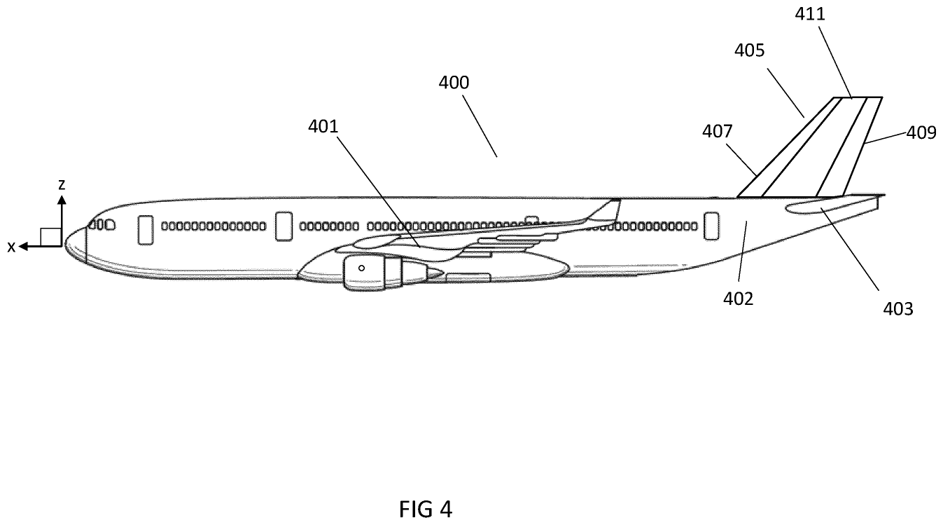

Each first aerostructure portion 201 and corresponding second aerostructure portion 203 further comprise an outer aerodynamic surface with planform areas S1 and S2, respectively. A total aerodynamic planform area S of the first aerostructure portion 201 and corresponding second aerostructure portion 203 is equal to the sum of the first aerodynamic planform area S1 and the corresponding second aerodynamic planform area S2. The total planform area S of the leading edge 107, trailing edge 109 and torsion box assembly 111, either individually or as a whole, is sized to provide a vertical tail plane 105 which can generate sufficient aerodynamic force about the aircraft' Z axes so that the aircraft 100 may be controlled as needed during operation according to a predefined set of performance and certification requirements. The planform areas S1 of the first portions 201 of the leading edge 107, trailing edge 109 and torsion box assembly 111, either individually or as a whole, are also sized to provide sufficient aerodynamic force about the Z axes of a second aircraft 400 (see FIG. 4) of different design, which may be controlled as necessary during operation according to a further predetermined set of performance and certification requirements specified for the second aircraft 400.

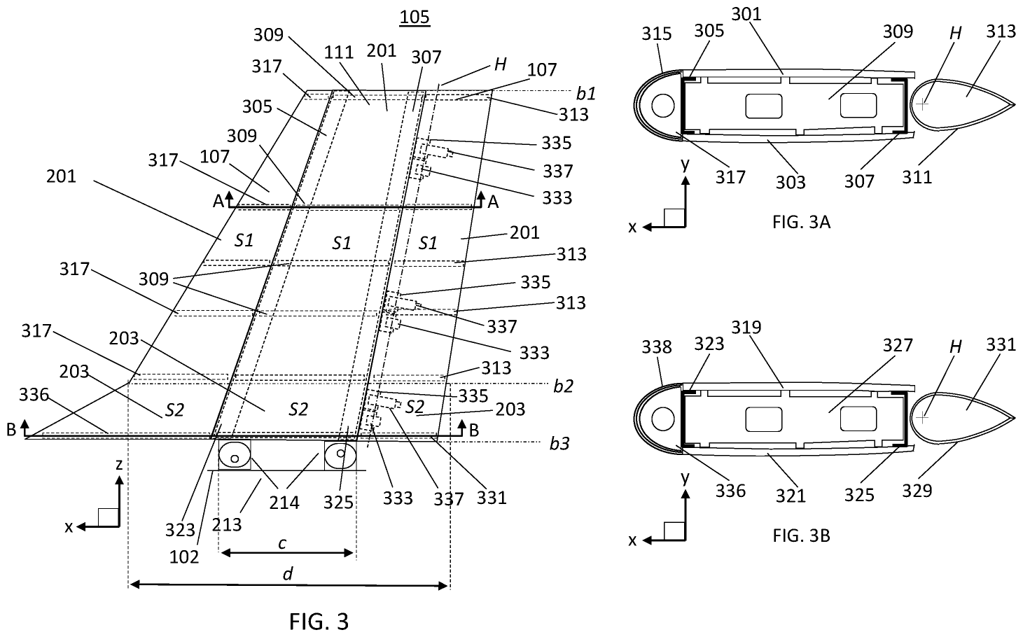

With reference to FIGS. 3, 3A and 3B, the first aerostructure portion 201 of the torsion box 111 comprises leading edge and trailing edge spar portions 305, 307 and a plurality of ribs 309 partially bounded by (enclosed by) a cover portion 301 and further cover portion 303 extending approximately in spanwise direction between a first and a second spanwise position, b1, b2. The spar portions 305, 307 are aligned approximately in a spanwise direction and formed of a carbon fibre composite material. The spars 305, 307 are fixedly attached to the covers 301, 303 and the ribs 309 by mechanical fasteners, however any other suitable form of mechanical attachment such as bonding may be used. The ribs 309 are aligned approximately in chordwise direction and are milled from an aluminium alloy material, although composite material may alternatively be used.

The first aerostructure portions 201 of the leading edge and trailing edge assemblies 107, 109 are constructed without a spar and each comprise a plurality of metallic ribs 317, 313 enclosed by a composite cover portion 311, 315. The covers may alternatively be formed from a metallic material. The metallic ribs 317 and cover 315 of the leading edge assembly 107 are fixedly attached to the leading edge spar portion 305 of the torsion box assembly 111. The trailing edge assembly 109 is also known as a rudder and is pivotably attached to the torsion box assembly 111 by a pair of hinge assemblies 333 that are attached to the trailing edge spar portion 307 of the torsion box 111 and the trailing edge assembly 109 to form a hinge line H between the trailing edge assembly 109 and the torsions box assembly 111. The first aerostructure portion 201 of the torsion box assembly trailing edge rudder assembly 109 also comprises a pair of actuator support brackets 335 attached to the spar portion 307 of the torsion box 111 and a pair of actuators 337 that are pivotably attached to the brackets 335 and the trailing edge assembly 109 such that they can actuate the trailing edge assembly 109.

The second aerostructure portion 203 of the leading edge assembly 107, torsion box 111 and trailing edge assembly 109 comprise substantially the same type of structural components and their general arrangement as the first aerostructure portions 201 from which they extend from. The second aerostructure portion 203 of the torsion box 111 comprises leading edge and trailing edge spar portions 323, 325 and a plurality of ribs 327 partially bounded by (enclosed by) an opposite cover portion 319 and further opposite cover portion 321 extending approximately in a spanwise direction between the second and a third spanwise position, b2, b3. The spar portions 323, 325 are again aligned approximately spanwise and formed of a carbon fibre composite material and are fixedly attached to the covers 319, 321 and the ribs 327 by mechanical fasteners, however any other suitable form of mechanical attachment such as bonding may be used. The ribs 327 are aligned approximately in a chordwise direction and milled from an aluminium alloy material, however they may alternatively be formed from a composite material. The second aerostructure portions 203 of the leading edge and trailing edge assemblies 107, 109 are also constructed without a spar and each comprise a plurality of metallic ribs 336, 331 enclosed by a composite cover portion 338, 329, respectively. The ribs 336 and cover 338 of the leading edge assembly 107 are fixedly attached to the leading edge spar portion 323 of the torsion box assembly 111. The trailing edge assembly 109 is also known as a rudder and is also pivotably attached to the torsion box assembly 111 by a pair of hinge assemblies 333 that are attached to the trailing edge spar portion 325 of the torsion box 111 and the trailing edge assembly 109 to form the same hinge line H between the trailing edge assembly 109 and the torsions box assembly 111. The corresponding second aerostructure portion 203 of the torsion box assembly 111 also comprises an actuator support bracket 335 attached to the spar portion 325 of the torsion box 111 and an actuator 337 that is pivotably attached to the bracket 335 and the trailing edge assembly 109 such that it can assist actuating the trailing edge assembly 109.

The cover portion 301 of the first aerostructure portion 201 of the torsion box 111 and the further cover portion 305 of the corresponding second aerostructure portion 203 of the torsion box 111 are formed during manufacture as a unitary component, meaning that the further cover portion 305 extends continuously from the cover portion 301 in the spanwise direction and that during manufacture, they are formed as a single piece of CFRP with substantially the same composite layup formed on a single mould tool using a single manufacturing process. In other words the cover portion 301 and the further cover portion 305 are a single structural component that extends between the first position b1 and third position b3. The structural component characteristics in terms of material, dimensions and performance are also the same for the opposite cover portion 319 and further opposite cover portion 321 of the torsion box assembly 111. Similarly, the structural component characteristics are also the same for the covers 315, 338 of the first and second aerostructure portion 201, 203 of the leading edge assembly 107 as are the structural component characteristics also the same for the covers 311, 329 of the first and second aerostructure portion 201, 203 of the trailing edge assembly 109. Alternatively the cover 301 and further cover 303 as well as the opposite cover 309 and further opposite cover 311 may be formed as non-unitary components but again using the same single mould tool respectively and joined using splice plates separately.

The leading edge and trailing edge spar portion 305, 307, 323, 325 of the first aerostructure portion 201 and second aerostructure portion 203 may in addition be formed as unitary components using a single mould tool and process for the leading edge and trailing edge spar portions respectively.

The vertical tail assembly 105 furthers comprises an attachment assembly 213 configured to attach the second corresponding portion of the aerostructure assembly 105 to a further aerostructure assembly of the aircraft which in this case is the aircraft fuselage 102. The attachment assembly 213 comprises a pair of lugs 214 per side each configured to be attached by a pin (not shown) to at least one corresponding clevis each 216. The distance d between the lugs 213 is less than or equal to the chord length of the first aerostructure portion 201 at the second position b2.

The lugs 213 are integrally formed with the further cover portion 309 and further opposite cover portion 311 or in the case of a smaller vertical tail 105 for a second aircraft 400, the cover portion 301 and opposite cover portion 303. In the case of the leading edge assembly 107 or trailing edge assembly 109, a lug 213 may be integrated with at least one rib 313, 317 for the first aerostructure portion 201 or 331 or 336 for the second aerostructure portion 203.

The lugs 213 may however be separate fittings mechanically fastened to the cover portion 301, the opposite cover portion 303 or the further cover portion 309 and further opposite cover portion 311.

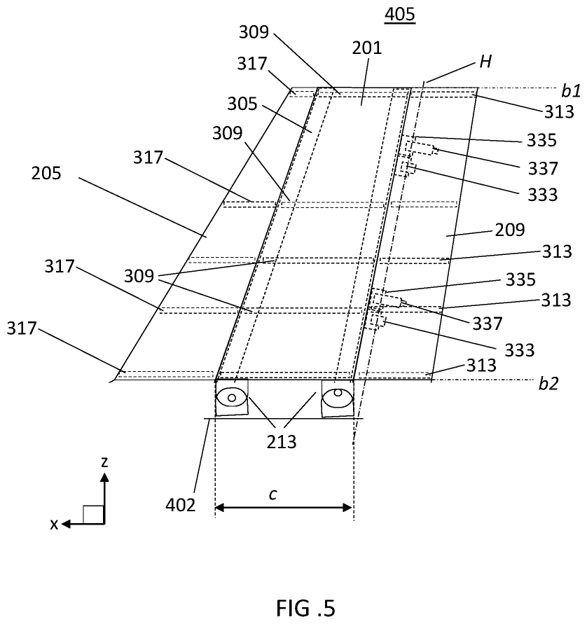

With reference to FIG. 4 and FIG. 5, a vertical tail plane 405 further comprising a torsion box assembly 411 a leading edge assembly 407 and a trailing edge assembly 409 is shown fitted to a second aircraft 400. The vertical tail plane 405 comprises only the first aerostructure portion 201 that is has the exact same aerodynamic and structural component design as the leading edge, trailing edge and torsion box assemblies 107, 109, 111 used for the vertical tail plane 105 of FIG. 1, 2, 3, 3A and 3B. The second aircraft 400 therefore has a smaller vertical tail plane 405 that is suited to the shorter fuselage 402 and reduced aerodynamic and structural requirements of the of the second aircraft 400, but with complete commonality and interchangeability of the structural components with the first aerostructure portion 201 of the vertical tail plane 105 of the first aircraft 100.

While at least one exemplary embodiment of the present invention(s) is disclosed herein, it should be understood that modifications, substitutions and alternatives may be apparent to one of ordinary skill in the art and can be made without departing from the scope of this disclosure. For example, it should be appreciated that components of the first and second aerostructure portions 201 203 such as the covers may extend continuously in a chordwise rather a spanwise direction in order to achieve the same advantages so far described.

In a further example only one type of sub-assembly for aerostructure assembly 107, 109, 111 may be designed according to the present invention such that part interchangeability and commonality is maintained on for a first portion of the torsion box assembly 111, 411 that may be used on a first and second aircraft 100, 400, respectively. This disclosure is intended to cover any adaptations or variations of the exemplary embodiment(s).

In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aerostructure assembly of an aircraft comprising:
a first aerostructure portion extending in a direction between a first position and a second position and comprising structurally of at least one rib or spar portion at least partially enclosed by at least one cover portion;
a corresponding second aerostructure portion connected to the first aerostructure portion and extending continuously in the direction from the first aerostructure portion between the second position and a third position and comprising structurally of at least one further rib or further spar portion at least partially enclosed by at least one further cover portion;
wherein the first aerostructure portion has a first aerodynamic planform area and the corresponding second aerostructure portion has a corresponding second aerodynamic planform area;
wherein a total aerodynamic planform area of the first aerostructure portion and corresponding second aerostructure portion is equal to the sum of the first aerodynamic planform area and the corresponding second aerodynamic planform area;
wherein the total aerodynamic planform area and structural component characteristics of the first aerostructure portion and the corresponding second aerostructure portion are defined such that the aerostructure assembly is sized for use on the aircraft; and, wherein the aerodynamic planform area and the structural component characteristics of the first aerostructure portion are in addition sized for use on a second aircraft.

2. An aerostructure assembly according to claim 1, wherein the cover portion of the first aerostructure portion and the further cover portion of the corresponding second aerostructure portion are formed as a unitary component.

3. An aerostructure assembly according to claim 1, wherein the spar portion of the first aerostructure portion and the further spar portion of the corresponding second aerostructure portion are formed as a unitary component.

4. An aerostructure assembly according to claim 1, wherein the first aerostructure portion comprises at least one hinge, at least one actuator support bracket and at least one actuator suited for use on both the first aircraft and the second aircraft.

5. An aerostructure assembly according to claim 1, further comprising an attachment assembly configured to attach the second corresponding portion of the aerostructure assembly to a further aerostructure assembly of the aircraft, wherein the attachment assembly comprises at least two lugs each configured to be attached by a pin to at least one corresponding clevis, and wherein the distance between the lugs is less than or equal to the length of the first aerostructure portion at the second position.

6. An aerostructure assembly according to claim 7, wherein the lugs are integrally formed with the cover portion, the further cover portion or the at least one further rib of the second corresponding portion.

7. An aerostructure assembly according to claim 6, wherein the lugs are separate fittings mechanically fastened to the cover portion, the further cover portion or the at least one further rib of the second corresponding portion.

8. An aerostructure assembly according to claim 1, wherein the first and second aerostructure portions are portions of a leading edge assembly.

9. An aerostructure assembly according to claim 1, wherein the first and second aerostructure portions are portions of a trailing edge assembly.

10. An aerostructure assembly according to claim 1, wherein the first and second aerostructure portions are portions of a torsion box assembly.

11. An aircraft vertical tail plane comprising an aerostructure assembly according to claim 1.

12. An aircraft horizontal tail plane comprising an aerostructure assembly according to claim 1.

13. An aircraft wing comprising an aerostructure assembly according to claim 1.

14. An aircraft comprising an aerostructure assembly according to claim 1.
